(19) United States
(12) Patent Application Publication
(10) Pub. No.: US 2004/0052971 A1
(43) Pub. Date: Mar. 18, 2004

(54) Method for making an extreme ultraviolet microlithography tranmission modulator and resulting modulator

(76) Inventors: Andre Golanski, Pologne (FR); Fabrice Piazza, Saint Die (FR); Ana Lacoste, St. Martin Le Vinoux (FR); Yves Alban Marie Arnal, Poisat (FR); Jacques Henri,Lucien Pelletier, St. Martin D'Heres (FR)

Correspondence Address: YOUNG & THOMPSON, 745 SOUTH 23RD STREET 2ND FLOOR, ARLINGTON, VA, 22202

(21) Appl. No.: 10/296,053

(22) PCT Filed: May 17, 2001
(86) PCT No.: PCT/FR01/01521

(30) Foreign Application Priority Data
May 22, 2000 (FR) 00/06521

(51) Int. Cl. H05H 1/24

(52) U.S. Cl. 427/569

(57) ABSTRACT

The invention concerns a method for making an extreme ultraviolet microlithography transmission modulator, characterised in that it consists in obtaining adamantine amorphous carbon by a process using a plasma consisting of a mixture of acetylene and argon and maintained by the power of a microwave source; in depositing a thin adamantine amorphous carbon film on a substrate with low absorption in extreme ultraviolet whereto is applied a variable polarisation; in varying the forbidden band between 1 and 2 eV through control of the argon partial pressure and in varying the corresponding extinction coefficient so as to modulate the modulator transmission without modifying the thickness of the deposited film.

The present invention relates to the production of transmission and phase modulators for deep ultraviolet microlithography, and relates more particularly to the production of transmission modulators with variable transmission aperture for deep ultraviolet microlithography (157 nm).

The methods and the materials which are currently used in microlithography at 248 nm cannot be used in deep UV: for wavelengths less than 193 nm, the absorption coefficients of the materials are much too high. Considerable effort is being directed at present to developing new materials which can be used in deep UV.

Adamantine amorphous carbon (DLC) is amongst the new materials proposed for the applications in deep ultraviolet microlithography. The technique recently proposed by Lucent Technologies enables production of the transmission modulators from DLC. DLC is an absorbent material, such that the transmission can be modulated by varying the thickness of the layer of DLC. The principal limitation of the Lucent Technologies technique comes from the intrinsic stress which is always present in DLC. The stress increases with the thickness and can lead to delamination or destruction of the film. The presence of the stress limits the thickness of the film and the corresponding attenuation of the transmission.

Another drawback of the technique proposed by Lucent Technologies resides in the convolution of the transmission modulation and of the phase modulation.

The object of the invention is to remedy the drawbacks of the prior art which are set out above.

It therefore relates to a method of producing a deep ultraviolet microlithography transmission modulator, characterised in that it consists of obtaining adamantine amorphous carbon by a method using a plasma composed of a mixture of acetylene and argon and maintained by the power of a microwave source, depositing a thin film of adamantine amorphous carbon on a substrate with low absorption in deep ultraviolet to which a variable polarisation is applied, varying the forbidden band by controlling the argon partial pressure and thus varying the corresponding extinction coefficient in order to modulate the modulator transmission without modifying the thickness of the deposited film.

According to other characteristics:

the forbidden band is varied between 1 and 2 eV by control of the argon partial pressure between 0 and 0.5 mTorr and preferably between 0.1 and 0.4 mTorr;

the corresponding extinction coefficient varies between 0.012 and 0.150;

the thickness of the film is modified by varying the duration of the deposition of the said film.

The invention also relates to:

a deep ultraviolet microlithography transmission modulator, characterised in that it is produced according to the method defined above;

the modulator is produced according to the method defined above by modifying the thickness of the film in order to ensure that the said transmission modulator has the function of phase modulator.

The invention will be better understood by reading the following description which is given solely by way of example and with reference to the accompanying drawings, in which:

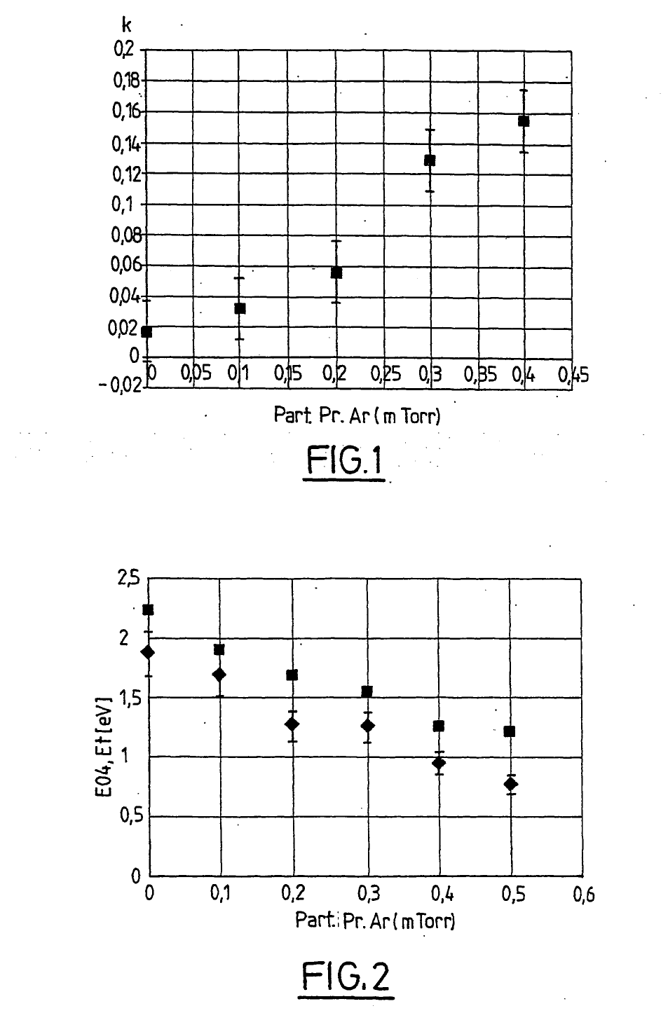

FIG. 1 is a graph showing the extinction coefficient (k) as a function of the argon partial pressure;

FIG. 2 is a graph showing the forbidden band Tauc and E04 as a function of the argon partial pressure; and

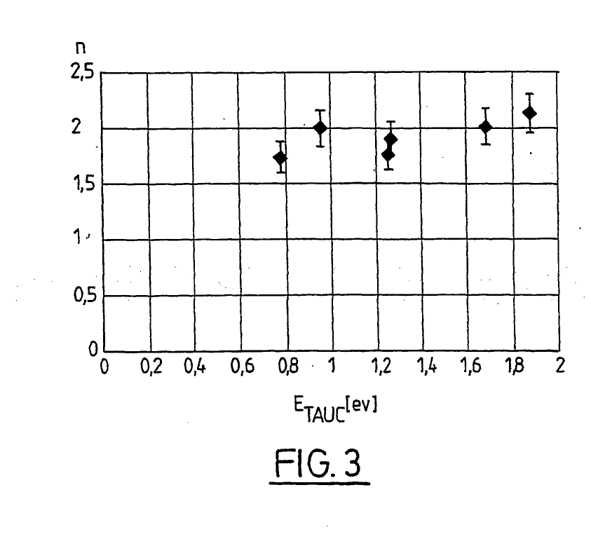

FIG. 3 is a graph showing the refractive index as a function of the forbidden band.

The material used within the scope of the invention is adamantine amorphous carbon (diamond-like carbon, DLC). In some ways close to diamond but incomparably more expensive, DLC is a material without long-distance order containing the mixture of different states of hybridisation (sp² and sp³).

It exists in a multitude of forms which differ in the microstructure, the macroscopic density, the width of the optical gap or forbidden band, the refractive index, the absorption coefficient, the microhardness, the heat stability, etc.

Its physical properties of particular interest, which include great hardness, resistance to friction, low dynamic and static friction, thermal conductivity similar to that of copper, etc., make it a preferred material for very varied applications.

The aim of the invention is to control the engineering of the forbidden band of DLC with a view to optimising its properties in relation to applications in deep ultraviolet microlithography. The engineering of the forbidden band of DLC is the subject of a study currently being carried out at the CNRS.

The deposition of DLC developed by the applicants is carried out as follows.

Thin layers of DLC are deposited by using immersion in plasma combined with the polarisation of the substrate. This permits control with precision and an excellent reproducibility of the parameters of the method such as the composition of the precursor gas, the density of the plasma, the electron temperature and the energy of the ions which reach the substrate.

Each of these parameters has an impact on the structure and the physical properties of the material. The deposition by means of plasma is effected at ambient temperature. The method of deposition is compatible with plates of 300 mm.

The results obtained have made it possible to demonstrate the relationship between the principal parameters of the method of deposition by means of plasma and the physical properties of the DLC deposited.

Thus it has been possible to demonstrate that the argon partial pressure in a precursor gas composed of a mixture of argon and acetylene has a direct impact on the width of the optical gap or forbidden band of DLC and consequently on the extinction coefficient. These results are illustrated in FIGS. 1 and 2.

According to the invention, active elements made from DLC are used and the transmission of monochromatic light through a layer of DLC is modulated by acting on the width of the forbidden band and on the corresponding extinction coefficient.

Deposition by means of plasma with a mixture of acetylene and argon is used in order to vary the width of the forbidden band. Varying the argon partial pressure results in modification of the processes of transfer of energy of the ions, the dynamics of nucleation and of growth of the DLC as well as its hybridisation. This makes it possible to act on the width of the forbidden band. The method proposed makes it possible to adjust the width of the forbidden band for a given thickness of DLC.

In a transparent medium the change of phase which accompanies the passage of a beam of monochromatic light through a thin film of thickness d depends essentially upon the refractive index (n) and the thickness.

For a wavelength λ the thickness required for a change of phase equal to π is:

d(π)=λ/4n.

For a given refractive index the change of phase can be varied by acting on the thickness of the film.

In an absorbent material the situation is more complex. One of the characteristics of the material DLC which is the subject of the present invention is that the refractive index evolves slowly as a function of the forbidden band as shown by the graph of FIG. 3.

According to the invention, active elements made from DLC are used in order to modulate the change of phase of the monochromatic light by acting on the thickness of the layer of DLC and possibly on the forbidden band.

Examples of conditions for carrying out the method according to the invention will now be described.

In so far as the proportion of acetylene and argon is concerned, the total pressure of the mixture of acetylene and argon is given by the relationship:

P=Pₐᵣ+P_{C2H2}=0.8 mTorr

and

0.1<Pₐᵣ<0.4 mTorr.

This results in a proportion of argon and acetylene (Pₐᵣ/P_{C2H2}) between 1/7 and 1.

The power of the microwave source is for example from 600 to 2000 Watts.

The substrate with low absorption in deep ultraviolet is a substrate made from CaF₂ or from quartz or from fused silica with a low OH content.

Within the range of pressures indicated, the gap or forbidden band is given by the following relation E_{TAUC}=1.

The method according to the invention has the following technical advantages.

The cost of lithography represents approximately one third of the cost of producing a microprocessor. The development of microlithography tools with high performance and low cost for the user is fundamental for the profitability of the production of silicon integrated circuits. The technique of producing the optical elements of deep UV microlithography which is proposed within the scope of the present invention represents a very competitive solution taking account in particular of the following elements:

thermal budget (deposition at ambient temperature)

modest investment in equipment and low cost of use for a technique compatible with dimensions of 300 mm.

1. Method of producing a transmission modulator for deep ultraviolet microlithography, characterised in that it consists of obtaining adamantine amorphous carbon by a method using a plasma composed of a mixture of acetylene and argon and maintained by the power of a microwave source, depositing a thin film of adamantine amorphous carbon on a substrate with low absorption in deep ultraviolet to which a variable polarisation is applied, varying the forbidden band by controlling the argon partial pressure and thus varying the corresponding extinction coefficient in order to modulate the modulator transmission without modifying the thickness of the deposited film.

2. Method as claimed in claim 1, characterised in that the proportion of argon and acetylene in the said mixture (Pₐᵣ+P_{C2H2}) is between 1/7 and 1.

3. Method as claimed in one of claims 1 and 2, characterised in that the power of the microwave source is between 600 and 2000 W.

4. Method as claimed in one of claims 1 to 3, characterised in that the forbidden band is given by the relationship E_{TAUC}=1.

5. Method as claimed in one of claims 1 and 4, characterised in that the substrate with low absorption in deep ultraviolet is made from CaF₂ or from quartz or from fused silica with a low OH content.

6. Method as claimed in one of claims 1 to 5, characterised in that the forbidden band is varied between 1 and 2 eV by control of the argon partial pressure between 0 and 0.5 mTorr and preferably between 0.1 and 0.4 mTorr.

7. Method as claimed in claims 1 to 8, characterised in that the corresponding extinction coefficient varies between 0.012 and 0.150.

8. Method as claimed in one of claims 1 to 7, characterised in that the thickness of the film is modified by varying the duration of the deposition of the said film.

9. Deep ultraviolet microlithography transmission modulator, characterised in that it is produced by the method as claimed in one of claims 1 to 8.

10. Transmission modulator as claimed in claim 9, characterised in that it is produced by the method as claimed in claim 8 in which the control of the thickness of the film makes it possible to ensure that the said transmission modulator has the function of phase modulator.
